(19) United States
(12) Patent Application Publication
(10) Pub. No.: US 2015/0159596 A1
(43) Pub. Date: Jun. 11, 2015

(54) BLOWBY GAS VENTILATION SYSTEM FOR SUPERCHARGER-EQUIPPED INTERNAL COMBUSTION ENGINE

(71) Applicant: Tsutomu Wakiya, Toyota-shi (JP)

(72) Inventor: Tsutomu Wakiya, Toyota-shi (JP)

(73) Assignee: TOYOTA JIDOSHA KABUSHIKI KAISHA, Toyota-shi, Aichi-ken (JP)

(21) Appl. No.: 14/411,747

(22) PCT Filed: Oct. 7, 2013
(86) PCT No.: PCT/IB2013/002327

§ 371 Date: Dec. 29, 2014

(30) Foreign Application Priority Data
Oct. 16, 2012 (JP) 2012-229001

(51) Int. Cl. F02M 25/08; F01M 13/02

(52) U.S. Cl. CPC F02M 25/08; F01M 13/02

(57) ABSTRACT

A blowby gas ventilation system for a supercharger-equipped internal combustion engine, which discharges blowby gas from a crankcase into intake air, includes a positive crankcase ventilation passage through which the blowby gas is delivered from the crankcase to an intake passage. The positive crankcase ventilation passage branches, in an intermediate location in the positive crankcase ventilation passage, into a first path that is used during natural aspiration of the internal combustion engine and a second path that is used during supercharging of the internal combustion engine, and a part of the positive crankcase ventilation passage, which includes a branching portion between the first path and the second path, is formed integrally with a cylinder head of the internal combustion engine.

### BACKGROUND OF THE INVENTION

1. Field of the Invention

The invention relates to a blowby gas ventilation system for a supercharger-equipped internal combustion engine.

2. Description of Related Art

As a blowby gas ventilation system that discharges blowby gas from a crankcase, there is known a system described in Japanese Patent Application Publication No. 2009-250159 (JP 2009-250159 A). In the blowby gas ventilation system described in JP 2009-250159 A, a part of a positive crankcase ventilation (PCV) passage through which blowby gas flows from the crankcase to an intake passage, and an oil separator chamber that separates an oil component from blowby gas are formed integrally within a cylinder head.

During natural aspiration of the internal combustion engine, blowby gas in the crankcase can be discharged by sucking blowby gas from the crankcase into the PCV passage formed to connect an area downstream of the throttle valve in the intake passage to the crankcase, by using negative intake pressure caused downstream of the throttle valve. However, in the case of a supercharger-equipped internal combustion engine, during supercharging, positive pressure is caused in the area downstream of the throttle valve in the intake passage, and thus, it is not possible to discharge blowby gas in the aforementioned manner, that is, it is not possible to discharge blowby gas through the use of intake negative pressure. In this regard, in the aforementioned related-art blowby gas ventilation system, consideration is not given to the discharging of blowby gas from the crankcase during supercharging, and therefore blowby gas can be discharged from the crankcase only during natural aspiration.

### SUMMARY OF THE INVENTION

The invention provides a blowby gas ventilation system for a supercharger-equipped internal combustion engine, which is able to discharge blowby gas both during supercharging and during natural aspiration, while complication of the configuration thereof is suppressed.

An aspect of the invention relates to a blowby gas ventilation system for a supercharger-equipped internal combustion engine, which is applied to an internal combustion engine including a supercharger, and which discharges blowby gas from a crankcase into intake air. The blowby gas ventilation system includes a positive crankcase ventilation passage through which the blowby gas is delivered from the crankcase to an intake passage. The positive crankcase ventilation passage branches, in an intermediate location in the positive crankcase ventilation passage, into a first path that is used during natural aspiration of the internal combustion engine and a second path that is used during supercharging of the internal combustion engine, and a part of the positive crankcase ventilation passage, which includes a branching portion between the first path and the second path, is formed integrally with a cylinder head of the internal combustion engine.

In the foregoing blowby gas ventilation system, a portion of the PCV passage which extends from the crankcase to the cylinder head is shared by the two paths that are used during natural aspiration and during supercharging, and that form the PCV passage. Therefore, the configuration is made simpler. Thus, it is possible to discharge the blowby gas both during supercharging and during natural aspiration while suppressing complication of the configuration.

During supercharging, an increased amount of blowby gas needs to be discharged from the crankcase, and thus, the amount of oil carried away by the blowby gas increases. In this regard, when the downstream-side opening of the first path in the cylinder head is formed in the side surface of the cylinder head and the downstream-side opening of the second path in the cylinder head is formed in the upper surface of the cylinder head, the second path extends upward from the branching portion. Thus, due to the action of gravity, an increased amount of oil is separated from the blowby gas that flows in the second path, and therefore the amount of oil carried away by the blowby gas can be reduced.

During supercharging, the blowby gas may be discharged, for example, by an ejector provided in a circulation passage through which intake air flows from an area downstream of the supercharger to an area upstream of the supercharger. In this case, when the ejector is fitted to a head cover, the second path can be connected to the ejector, without extending outside the internal combustion engine. Thus, the configuration is made simpler.

Furthermore, an enlarged chamber may be formed in the part of the positive crankcase ventilation passage, and a flow passage area of the enlarged chamber, through which the blowby gas flows, may be larger than that of an upstream portion of the part of the positive crankcase ventilation passage, the upstream portion being located upstream of the enlarged chamber. In this case, oil is separated from the blowby gas due to changes in flow speed caused when the blowby gas flows into the enlarged chamber and when the blowby gas flows out of the enlarged chamber, and thus, the amount of oil carried away by the blowby gas can be reduced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a diagram schematically showing an entire configuration of a blowby gas ventilation system for a supercharger-equipped internal combustion engine according to an embodiment of the invention;

FIG. 2 is a diagram showing the position of an in-head passage in a cylinder head in the blowby gas ventilation system according to the embodiment;

FIG. 3 is a perspective view showing a perspective-view structure of the in-head passage in the blowby gas ventilation system according to the embodiment;

FIG. 4 is a side view of a side-view structure of the in-head passage in the blowby gas ventilation system according to the embodiment;

FIG. 5 is a diagram showing flows of air and blowby gas in the blowby gas ventilation system according to the embodiment during natural aspiration of the internal combustion engine; and

FIG. 6 is a diagram showing flows of air and blowby gas in the blowby gas ventilation system according to the embodiment during supercharging of the internal combustion engine.

### DETAILED DESCRIPTION OF EMBODIMENTS

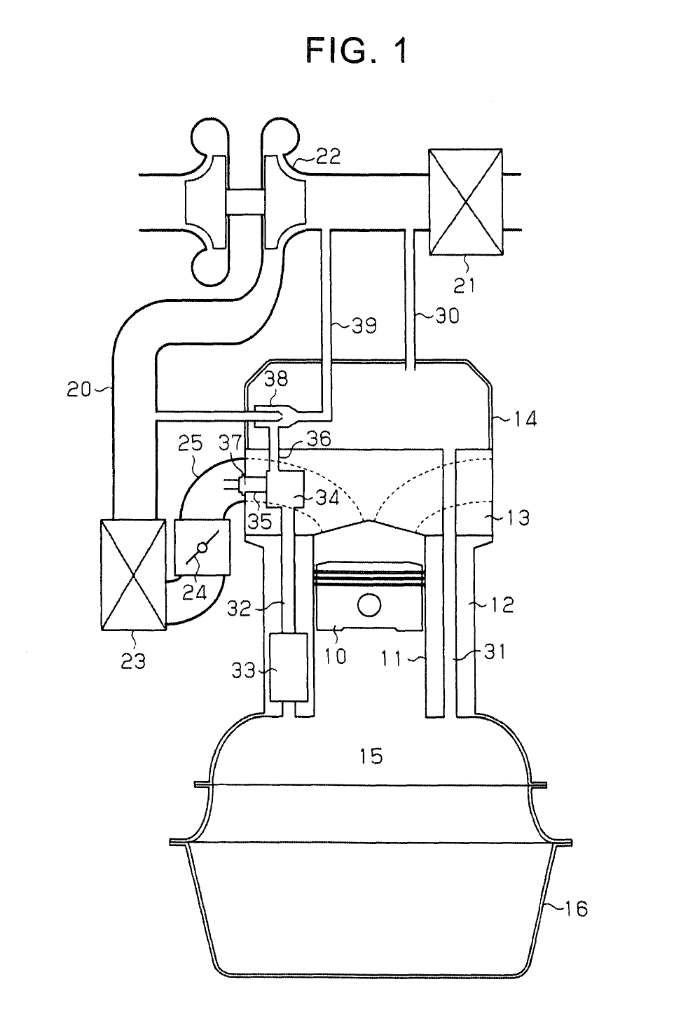

Hereinafter, a blowby gas ventilation system for a supercharger-equipped internal combustion engine according to an embodiment of the invention will be described in detail with reference to FIG. 1 to FIG. 6. As shown in FIG. 1, a cylinder block 12 of the internal combustion engine is provided with cylinders 11 in each of which a piston 10 is disposed so that the piston 10 is able to reciprocate. On an upper portion of the cylinder block 12, there is provided a cylinder head 13. On an upper portion of the cylinder head 13, a head cover 14 is provided. On the other hand, at a lower portion of the cylinder block 12, there is formed a crankcase 15. An oil pan 16 that stores lubricating oil of the internal combustion engine is fitted to a lower portion of the crankcase 15.

In an intake passage 20 of the internal combustion engine, there are provided, in order from the upstream side, an air cleaner 21 that filters air introduced into the intake passage 20, a compressor 22 of a turbocharger, which is an exhaust-driven supercharger, an intercooler 23 that cools air whose temperature has been increased by supercharging, and a throttle valve 24 that adjusts the intake air flow rate. The intake passage 20 is connected to the cylinder head 13 via an intake manifold 25 that is provided downstream of the throttle valve 24.

The supercharger-equipped internal combustion engine described above is provided with a blowby gas ventilation system that discharges blowby gas that has leaked into the crankcase 15 through a space between the sliding contact surfaces of the pistons 10 and the cylinders 11. The blowby gas ventilation system includes a fresh air introduction passage through which fresh air is introduced into the crankcase 15 during the discharging of blowby gas, and a positive crankcase ventilation (PCV) passage through which blowby gas is delivered from the crankcase 15 to the intake passage 20. Of these two passages, the fresh air introduction passage is formed by a fresh air introduction pipe 30 and a fresh air introduction passage 31. The fresh air introduction pipe 30 connects an area downstream of the air cleaner 21 in the intake passage 20, to a head cover 14. The fresh air introduction passage 31 is formed in the cylinder head 13 and the cylinder block 12 so as to provide communication between the inside of the head cover 14 and the crankcase 15.

On the other hand, the PCV passage of the blowby gas ventilation system is configured as follows. That is, an in-block passage 32 is formed within the cylinder block 12. The in-block passage 32 is formed so as to extend through the cylinder block 12 from the crankcase 15 to an upper surface of the cylinder block 12. Furthermore, in an intermediate location in the in-block passage 32, there is provided an oil separator 33 that removes an oil content from the blowby gas that flows inside the oil separator 33. In this embodiment, the oil separator 33 employed is a cyclone separator that separates an oil content from blowby gas by centrifugal separation that is performed by causing swirl flows inside the oil separator 33.

The in-block passage 32 is connected to an in-head passage 34 that is formed within the cylinder head 13. In the in-head passage 34, the PCV passage branches into a first path 35 that is used during natural aspiration of the internal combustion engine, and a second path 36 that is used during supercharging. The first path 35 is connected to the intake manifold 25 via a PCV valve 37. The PCV valve 37 opens and closes according to the differential pressure across the PCV valve 37, and prevents fresh air from reversely flowing from the intake manifold 25-side to the crankcase 15-side, and adjusts the flow rate of blowby gas introduced into intake air. On the other hand, the second path 36 is connected to an ejector 38 that is fitted to an inside of the head cover 14. The ejector 38 is provided in an intermediate location in a circulation passage 39 that provides communication between areas downstream and upstream of the compressor 22 in the intake passage 20. The ejector 38 functions as a jet pump that sucks in blowby gas from the crankcase 15 by using the stream of air flowing in the circulation passage 39. A connecting position which is located upstream of the compressor 22, and at which the circulation passage 39 is connected to the intake passage 20 is downstream of a connecting position at which the fresh air introduction pipe 30 is connected to the intake passage 20.

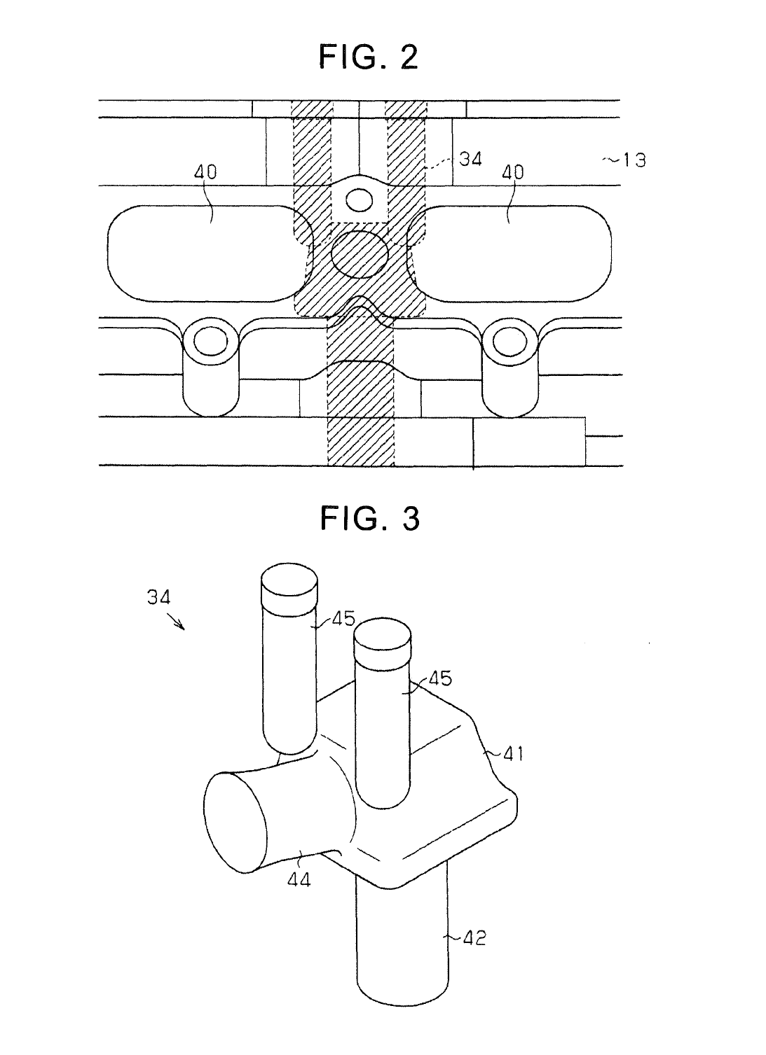

As shown in FIG. 2, the in-head passage 34 constituting a part of the PCV passage, which includes a branching portion between the first path 35 and the second path 36, is formed between intake ports 40 of two adjacent cylinders. As shown in FIG. 3, the in-head passage 34 extends upward from a lower surface of the cylinder head 13, and is connected to an enlarged chamber 41. The enlarged chamber 41 is formed so that the flow passage area of the enlarged chamber 41, through which blowby gas flows, is larger than that of an upstream portion of the in-head passage 34, the upstream portion being located upstream of the enlarged chamber 41 (hereinafter, the upstream portion will be referred to as a pre-branching passage 42). The enlarged chamber 41 functions as an oil separator that separates an oil content from blowby gas due to change in a flow speed resulting from change in the flow passage area. From the enlarged chamber 41, a natural aspiration-range passage 44 that forms the first path 35 extends obliquely upward, and supercharging-range passages 45 that form the second path 36 extend upward. In this blowby gas ventilation system, because of the restriction on the diameter of a hole that can be formed in the cylinder head 13, a portion of the in-head passage 34, which forms the second passage 36, is formed by the two supercharging-range passages 45 in order to secure a necessary flow passage area.

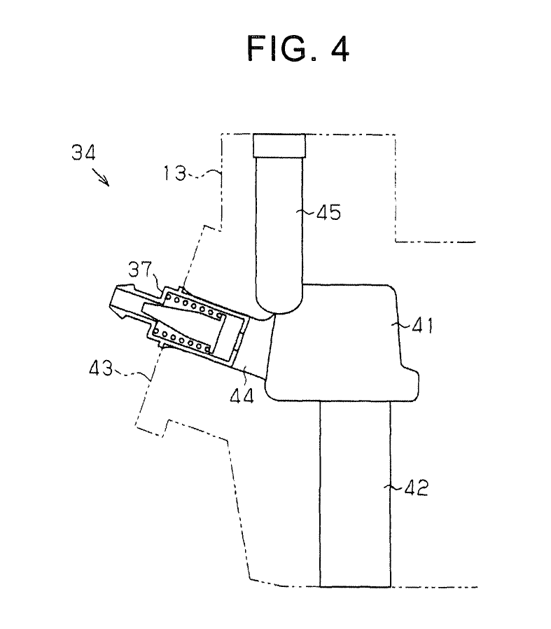

As shown in FIG. 4, a downstream-side opening of the natural aspiration-range passage 44 is formed in a side surface of the cylinder head 13 (more specifically, a fitting surface 43 to which the intake manifold 25 is fitted). The natural aspiration-range passage 44 is provided with the PCV valve 37. On the other hand, downstream-side openings of the supercharging-range passages 45 are formed in the upper surface of the cylinder head 13, to which the head cover 14 is fitted. The natural aspiration-range passage 44 and the enlarged chamber 41 of the in-head passage 34 are formed by core molding at the time of casting the cylinder head 13. The supercharging-range passages 45 and the pre-branching passage 42 are formed by a boring process after the casting process.

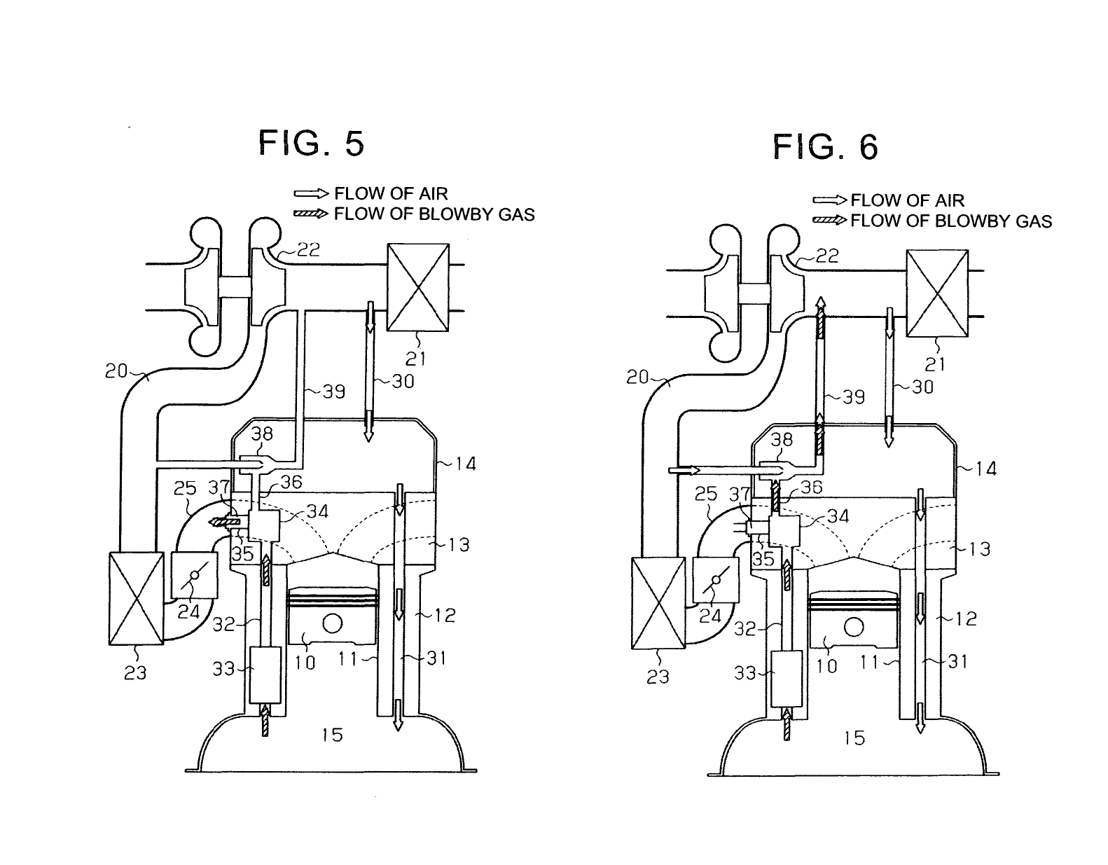

Next, operation of the blowby gas ventilation system for a supercharger-equipped internal combustion engine configured as described above will be described. As shown in FIG. 5, during the natural aspiration of the internal combustion engine, negative pressure is caused in the area downstream of the throttle valve 24 in the intake passage 20. At this time, the PCV valve 37 opens due to the differential pressure across the PCV valve 37. Due to the negative pressure in the intake manifold 25, blowby gas is sucked from the crankcase 15 into the intake manifold 25 via the in-block passage 32, the oil separator 33, the in-head passage 34, the natural aspiration-range passage 44 and the PCV valve 37. Furthermore, when blowby gas is discharged from the crankcase 15 in this manner, air in the intake passage 20 is introduced into the crankcase 15 via the fresh air introduction pipe 30 and the fresh air introduction passage 31. At this time, the pressure difference between the areas upstream and downstream of the compressor 22 in the intake passage 20 is small, and therefore air does not flow in the circulation passage 39, so that the ejector 38 does not operate.

On the other hand, during the supercharging of the internal combustion engine, the pressure in the area downstream of the compressor 22 in the intake passage 20 becomes higher than the pressure in the area upstream of the compressor 22 in the intake passage 20. At this time, a large pressure difference occurs between the areas upstream and downstream of the compressor 22 in the intake passage 20, and therefore, air flows in the circulation passage 39, so that the ejector 38 operates due to the stream of air. As shown in FIG. 6, due to the operation of the ejector 38, blowby gas is sucked from the crankcase 15 into the ejector 38 via the in-block passage 32, the oil separator 33, the in-head passage 34 and the second path 36. The blowby gas sucked into the ejector 38 is delivered into intake air in the area upstream of the compressor 22 in the intake passage 20, together with air flowing in the circulation passage 39. At this time, the PCV valve 37 is in a closed state, and thus, it is possible to prevent reverse flow of air from the intake manifold 25, in which the pressure has become high due to supercharging, into the crankcase 15.

During supercharging, the amount of blowby gas that leaks into the crankcase 15 is large, and therefore the large amount of blowby gas needs to be discharged from the crankcase 15. Then, if the flow rate of blowby gas discharged from the crankcase 15 increases, the amount of oil carried away by blowby gas also increases. In this regard, in this blowby gas ventilation system, the second path 36 through which blowby gas flows during supercharging extends upward in a vertical direction (i.e., extends in a direction opposite to the direction of gravity). Thus, gravity acts in a direction opposite to a direction in which blowby gas flows in the second path 36. Therefore, due to the action of gravity, an increased amount of oil is separated from blowby gas that flows in the second path 36, and therefore the amount of oil carried away by blowby gas can be reduced.

The above-described blowby gas ventilation system for the supercharger-equipped internal combustion engine has the following advantageous effects. (1) In this embodiment, the PCV passage that delivers blowby gas from the crankcase 15 to the intake passage 20 branches, in an intermediate location in the PCV passage, into the first path 35 that is used during natural aspiration of the internal combustion engine and the second path 36 that is used during the supercharging of the internal combustion engine. A part (the in-head passage 34) of the PCV passage, which includes the branching portion (the enlarged chamber 41) between the first path 35 and the second path 36, is formed integrally with the cylinder head 13. In this embodiment, a portion of the PCV passage, which extends from the crankcase 15 to the cylinder head 13, is shared by the two paths (the first and second paths 35, 36) that are used during natural aspiration and during supercharging, and that form the PCV passage. Therefore, a hose, a pipe, or the like is not required and the number of component parts is reduced. Accordingly, it is possible to discharge blowby gas from the crankcase both during supercharging and during natural aspiration while suppressing the complication of the configuration.

(2) In this embodiment, the downstream-side opening of the first path 35 (the natural aspiration-range passage 44) in the in-head passage 34 is formed in the side surface of the cylinder head 13 (the fitting surface 43 to which the intake manifold 25 is fitted), and the downstream-side opening of the second path 36 (the supercharging-range passages 45) in the in-head passage 34 is formed in the upper surface of the cylinder head 13. Therefore, the second path 36 extends upward in the vertical direction from the enlarged chamber 41 that is the branching portion of the PCV passage, that is, the second path 36 extends in the direction opposite to the direction of gravity. Thus, in the second path 36, blowby gas flows in the direction opposite to the direction in which gravity acts. Therefore, it is possible to suppress an increase in the amount of oil carried away by blowby gas when supercharging is performed, that is, when an increased amount of blowby gas needs to be discharged from the crankcase.

(3) In this embodiment, the ejector 38 is fitted to the head cover 14, and the second path 36 is connected directly to the ejector 38, without extending outside the internal combustion engine. This eliminates the need for a hose, a pipe or the like for connecting the second path 36 to the ejector 38, and therefore makes the configuration simpler.

(4) In this embodiment, in the in-head passage 34, the enlarged chamber 41 is formed, and the flow passage area of the enlarged chamber 41 is larger than the flow passage area of each of the upstream and downstream portions located upstream and downstream of the enlarged chamber 41. Therefore, oil is separated from blowby gas due to changes in flow speed caused when blowby gas flows into the enlarged chamber 41 and when blowby gas flows out of the enlarged chamber 41, and thus, the amount of oil carried away by blowby gas can be reduced.

The embodiment may be implemented with the following modifications. Although in the embodiment, the two supercharging-range passages 45 are provided, only one supercharging-region passage 45 may be provide, if it is possible to form a passage that has a sufficiently large diameter, in a cylinder head 13.

Although in the embodiment, the enlarged chamber 41 for separating oil is formed in the in-head passage 34, the enlarged chamber 41 may be omitted if the amount of oil carried away by blowby gas can be sufficiently reduced without providing the enlarged chamber 41.

Although in the embodiment, the ejector 38 is fitted to the inside of the head cover 14, the ejector 38 may be fitted to an outside of the head cover 14. In such a case as well, it is possible to connect the second path 36 to the ejector 38 without providing a hose or a pipe that extends outside the internal combustion engine.

Although in the embodiment, the ejector 38 is fitted to the head cover 14, the ejector 38 may also be fitted to a site other than the head cover 14 if it is difficult to fit the ejector 38 to the head cover 14 due to the layout of the circulation passage 39.

Although in the embodiment, blowby gas is discharged by using the ejector 38 during supercharging, blowby gas may be discharged by another method, for example, by using an electric pump or the like during supercharging. Although in the embodiment, the downstream-side opening of the first path 35 in the in-head passage 34 is formed in the side surface of the cylinder head 13 and the downstream-side opening of the second path 36 in the in-head passage 34 is formed in the upper surface of the cylinder head 13, the downstream-side openings may be formed at other sites on the cylinder head 13.

1. A blowby gas ventilation system for a supercharger-equipped internal combustion engine, which is applied to an internal combustion engine including a supercharger, and which discharges blowby gas from a crankcase into intake air, the blowby gas ventilation system comprising
a positive crankcase ventilation passage through which the blowby gas is delivered from the crankcase to an intake passage, wherein the positive crankcase ventilation passage branches, in an intermediate location in the positive crankcase ventilation passage, into a first path that is used during natural aspiration of the internal combustion engine and a second path that is used during supercharging of the internal combustion engine, and a part of the positive crankcase ventilation passage, which includes a branching portion between the first path and the second path, is formed integrally with a cylinder head of the internal combustion engine;
wherein a downstream-side opening of the first path in the cylinder head is formed in a side surface of the cylinder head, and a downstream-side opening of the second path in the cylinder head is formed in an upper surface of the cylinder head, and the second path extends upward from the branching portion.

2. The blowby gas ventilation system according to claim 1, wherein the blowby gas is discharged via the second path by sucking the blowby gas using an ejector provided in a circulation passage through which the intake air flows from an area downstream of the supercharger to an area upstream of the supercharger, and the ejector is fitted to a head cover.

3. The blowby gas ventilation system according to claim 1, wherein an enlarged chamber is formed in the part of the positive crankcase ventilation passage, and a flow passage area of the enlarged chamber, through which the blowby gas flows, is larger than that of an upstream portion of the part of the positive crankcase ventilation passage, the upstream portion being located upstream of the enlarged chamber.
